(19) United States
(12) Patent Application Publication
(10) Pub. No.: US 2019/0369435 A1
(43) Pub. Date: Dec. 5, 2019

(54) FLEXIBLE DISPLAY PANEL AND MANUFACTURING METHOD THEREOF

(71) Applicant: Wuhan China Star Optoelectronics Technology Co., Ltd., Wuhan (CN)

(72) Inventors: Bingkun YIN, Shenzhen (CN); Zhenhui CHEN, Shenzhen (CN)

(21) Appl. No.: 16/219,391

(22) Filed: Dec. 13, 2018

Related U.S. Application Data
(63) Continuation of application No. PCT/CN2018/101642, filed on Aug. 22, 2018.

(30) Foreign Application Priority Data
May 31, 2018 (CN) 201810551933.8

(51) Int. Cl. G02F 1/1333; G02F 1/1339; G02F 1/1362; G02F 1/1345

(52) U.S. Cl. CPC G02F 1/133305; G02F 1/13452; G02F 1/136209; G02F 1/13394

(57) ABSTRACT

This application provides a flexible display panel which includes a first flexible substrate, a second flexible substrate disposed opposite to the first flexible substrate, and a cut protection layer. The cut protection layer connects the edge of the first flexible substrate and the driving circuit connection layer. When the substrate in the cut region is cut by using laser, the cut protection layer will absorb a part of the excessive laser energy to reduce the risk of damaging the metal routing in the driving circuit connection layer by sacrificing itself when laser cutting is performed on the substrate at the side of the cut region of the flexible TFT-LCD and achieve the effect of protecting the metal routing in the cut region, thereby ensuring the display effect of the flexible TFT-LCD display panel.

### CROSS-REFERENCE TO RELATED APPLICATIONS

The present application is a continuation-application of International (PCT) Patent Application No. PCT/CN2018/101642 filed on Aug. 22, 2018, which claims foreign priority of Chinese Patent Application No. 201810551933.8, filed on May 31, 2018 in the National Intellectual Property Administration of China, the entire contents of which are hereby incorporated by reference.

### TECHNICAL FIELD

This application generally relates to the technical field of displaying, and more particularly, relates to a flexible display panel and a manufacturing method thereof.

### BACKGROUND

Flexible TFT-LCDs are characterized by an ultrathin profile, a light weight, being flexible and a high degree of freedom in design or the like, and thus have found wide application in wearable devices, mobile phone communication, televisions, commercial advertisements and military applications. A substrate material of flexible TFT-LCD generally includes ultrathin glass and colorless polyimide (PI) or the like, wherein the ultrathin glass is fragile, and the colorless PI has characteristics of being highly flexible and resistant to impact. Therefore, the colorless PI may serve as the substrate material of the flexible TFT-LCD. However, the introduction of the flexible substrate material PI makes the cutting of the flexible LCD difficult. More particularly, a transparent substrate at the side of the color filter is more difficult to cut, and because wheel cutting, or splitting is not applicable anymore, a picosecond laser is necessary for the cutting. However, the thickness of a liquid crystal cell of the TFT-LCD generally is only approximately 3 μm, so it is difficult to protect the metal routing at the TFT side from being damaged while cutting the transparent substrate at the side of the color filter. Any damage to the TFT metal routing will directly influence the display effect of the flexible TFT-LCD.

### SUMMARY

To prevent TFT metal routing from being damaged while cutting a transparent substrate at the side of a color filter by using laser, this application provides a flexible display panel having a cut protection layer and a manufacturing method thereof.

To solve the aforesaid technical problem, a technical solution provided by this application is to provide a flexible display panel, which may include: a first flexible substrate; a second flexible substrate, being disposed opposite to the first flexible substrate, at least one side of the second flexible substrate extending outside of the position where the first flexible substrate is projected onto the second flexible substrate; a driving circuit connection layer, being disposed on the second flexible substrate and partially disposed on a position of the second flexible substrate that extends outside of the position where the first flexible substrate is projected onto the second flexible substrate; wherein a black matrix layer is disposed on the first flexible substrate, and a cut protection layer is disposed between the black matrix layer that is disposed at an edge of the first flexible substrate and the driving circuit connection layer; the cut protection layer, connecting the edge of the first flexible substrate and the driving circuit connection layer to protect the driving circuit connection layer from being damaged by laser, the cut protection layer is a photoresist or a spacer wall of which the constituents are resins.

To solve the aforesaid technical problem, another technical solution provided by this application is to provide a flexible display panel which comprises: a first flexible substrate; a second flexible substrate, being disposed opposite to the first flexible substrate, at least one side of the second flexible substrate extending outside of the position where the first flexible substrate is projected onto the second flexible substrate; a driving circuit connection layer, being disposed on the second flexible substrate and partially disposed on a position of the second flexible substrate that extends outside of the position where the first flexible substrate is projected onto the second flexible substrate; a cut protection layer, connecting an edge of the first flexible substrate and the driving circuit connection layer to protect the driving circuit connection layer from being damaged by laser.

To solve the aforesaid technical problem, yet another technical solution provided by this application is to provide a method for manufacturing a flexible display panel, and the method comprises: acquiring a first flexible substrate and a second flexible substrate; forming a driving circuit connection layer at a side of the second flexible substrate that is towards the first flexible substrate; forming a cut protection layer between the driving circuit connection layer and the first flexible substrate, the cut protection layer corresponding to a position of the first flexible substrate on which laser cutting is to be performed; and cutting the first flexible substrate by using laser.

Benefits of this application are as follows: the flexible display panel of this application is provided with a cut protection layer; the cut protection layer may connect the edge of the first flexible substrate and the driving circuit connection layer to protect the driving circuit connection layer from being damaged by laser. By disposing the cut protection layer between the edge of the first flexible substrate and the driving circuit connection layer, the cut protection layer will absorb a part of the excessive laser energy when the substrate in the cut region is cut by using laser, so the risk of damaging the driving circuit connection layer is reduced when laser cutting is performed on the first flexible substrate to achieve the effect of protecting the metal routing in the cut region, thereby ensuring the display effect of the flexible TFT-LCD display panel.

### BRIEF DESCRIPTION OF THE DRAWINGS

In order to more clearly illustrate the technical solution in the embodiments of the present disclosure, the accompanying drawings to be used in the description of the embodiments are briefly described below. It will be apparent that the accompanying drawings in the following description are merely embodiments of the present disclosure, and other accompanying drawings may be obtained without creative work for those skilled in the art.

FIG. 1 is a schematic structural view of a flexible display panel according to a first embodiment provided in this application;

FIG. 2 is a schematic structural view of a flexible display panel according to a second embodiment provided in this application;

FIG. 3 is a schematic structural view of a flexible display panel according to a third embodiment provided in this application; and

FIG. 4 is a flowchart diagram of a method for manufacturing a flexible display panel according to a fourth embodiment provided in this application.

### DETAILED DESCRIPTION

The following will clearly and completely describe the technical solutions in the embodiments of the present disclosure with reference to the accompanying drawings in the embodiments of the present disclosure. It is to be understood that the specific embodiments described herein are only used to explain the present disclosure and are not intended to limit the present disclosure. It's obvious that only part but not all of the embodiments related to the present disclosure are provided. All other embodiments obtained based on the embodiments of the present disclosure by those skilled in the art without making creative efforts shall fall within the protection scope of the present disclosure.

To better understand the technical solutions of the present disclosure by those skilled in the art, a flexible display panel and a manufacturing method thereof provided in the present disclosure will be further described in detail hereinafter with reference to attached drawings and embodiments.

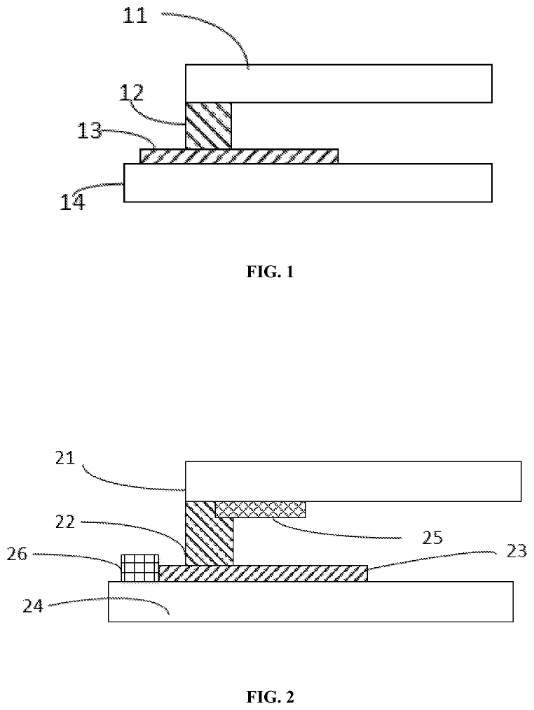

Referring to FIG. 1, FIG. 1 is a schematic structural view of a flexible display panel according to a first embodiment provided in this application. The flexible display panel in this embodiment may include: a first flexible substrate 11, a second flexible substrate 14, a driving circuit connection layer 13 and a cut protection layer 12.

The second flexible substrate 14 may be disposed opposite to the first flexible substrate 11, and at least one side of the second flexible substrate 14 extends outside of the position where the first flexible substrate 11 is projected onto the second flexible substrate 14. The driving circuit connection layer 13 may be disposed on the second flexible substrate 14 and partially disposed on a position of the second flexible substrate 14 that extends outside of the position where the first flexible substrate 11 is projected onto the second flexible substrate 14. The cut protection layer 12 may connect the edge of the first flexible substrate 11 and the driving circuit connection layer 13 to protect the driving circuit connection layer 13 from being damaged by laser.

In the aforesaid technical solution, by disposing the cut protection layer, the cut protection layer connects the edge of the first flexible substrate and the driving circuit connection layer to protect the driving circuit connection layer from being damaged by laser. The cut protection layer will absorb a part of the excessive laser energy when the substrate in the cut region is cut by using laser, so the risk of damaging the metal routing in the driving circuit connection layer may be reduced when laser cutting is performed on the substrate at the side of the cut region of the flexible TFT-LCD to achieve the effect of protecting the metal routing in the cut region, thereby ensuring the display effect of the flexible TFT-LCD display panel.

Referring to FIG. 2, FIG. 2 is a schematic structural view of a flexible display panel according to a second embodiment provided in this application. The flexible display panel in this embodiment may include: a first flexible substrate 21, a second flexible substrate 24, a driving circuit connection layer 23 and a cut protection layer 22.

This embodiment may differ from the first embodiment in that: a black matrix layer 25 is disposed on the first flexible substrate 21, the cut protection layer 22 is disposed between the black matrix layer 25 that is disposed at an edge of the first flexible substrate 21 and the driving circuit connection layer 23, and an IC chip 26 is disposed at an edge position of the second flexible substrate 24 and connected with the driving circuit connection layer 23.

In this embodiment, the material of the cut protection layer 22 may be an organic colloid. Preferably, the cut protection layer 22 may be an organic sealant. The organic colloid may absorb the excessive laser and may also provide the supporting function to a certain extent.

In the above technical solution, the organic sealant may connect the edge of the first flexible substrate and the driving circuit connection layer. In the related art, the thickness of the middle portion of the display panel is different from the thickness of the edge portion of the display panel when the first flexible substrate and the second flexible substrate are bent so that the display effect of the flexible display panel is influenced. In this embodiment, the organic sealant is disposed at the edge of the first flexible substrate and provides the function of supporting the first flexible substrate and the second flexible substrate so that the thickness of the middle portion of the display panel is the same as the thickness of the edge portion of the display panel when the first flexible substrate and the second flexible substrate are bent. Meanwhile, the driving circuit connection layer can be protected from being damaged by laser. When the substrate in the cut region is cut by laser, the organic sealant will absorb a part of the excessive laser energy to reduce the risk of damaging the metal routing in the driving circuit connection layer when laser cutting is performed on the substrate at the side of the cut region of the flexible TFT-LCD and achieve the effect of protecting the metal routing in the cut region, thereby ensuring the display effect of the flexible TFT-LCD display panel.

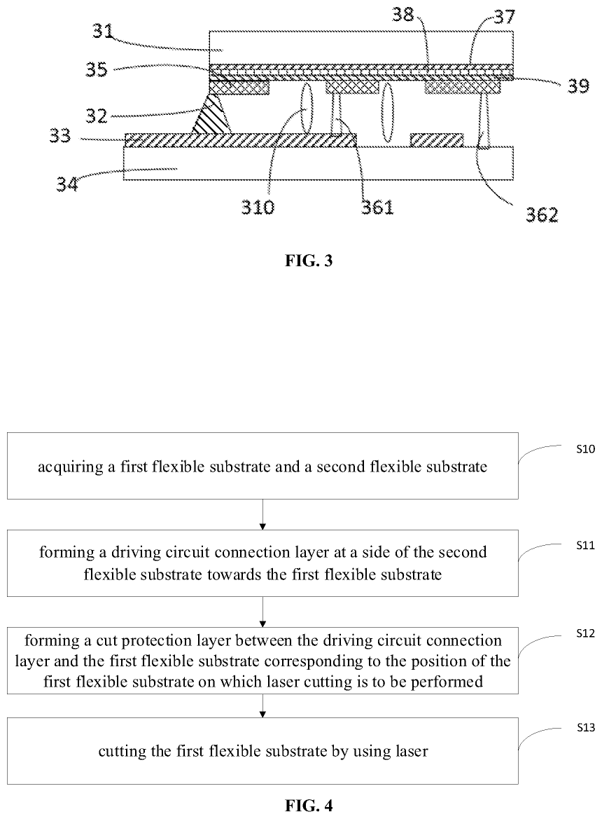

Referring to FIG. 3, FIG. 3 is a schematic structural view of a flexible display panel according to a third embodiment provided in this application. The flexible display panel in this embodiment may include: a first flexible substrate 31, a second flexible substrate 34, a driving circuit connection layer 33 and a cut protection layer 32.

This embodiment may differ from the first embodiment in that: a transparent electrode layer 37, a color filter film layer 38, an alignment film layer 39 and a black matrix layer 35 are sequentially disposed on the first flexible substrate 31; the cut protection layer 32 may be disposed between the black matrix layer 35 disposed at the edge of the first flexible substrate 31 and the driving circuit connection layer 33; a liquid crystal layer 310 may be disposed between the alignment film layer 39 and the second flexible substrate 34, which may control pixel display of the flexible display panel; a first supporting column 361 may be disposed between the black matrix layer 35 and the driving circuit connection layer 33, and a second supporting column 362 may be disposed between the black matrix layer 35 and the second flexible substrate 34. The first supporting column 361 and the second supporting column 362 may support the first flexible substrate 31 and the second flexible substrate 34.

Preferably, the cut protection layer 32 may connect the second flexible substrate 34 and the alignment film layer 39 and is located between the second flexible substrate 34 and an edge position of the alignment film layer 39.

Preferably, the cut protection layer 32 may connect the driving circuit connection layer 33 and the alignment film layer 39 and is located between the driving circuit connection layer 33 and an edge position of the alignment film layer 39.

Preferably, the cut protection layer 32 may connect the driving circuit connection layer 33 and the alignment film layer 39 and is located between the second flexible substrate 34 and an edge position of the alignment film layer 39, and may be connected with the black matrix layer 35.

Additionally, the cross-sectional area of the cut protection layer 32 may increase gradually from one end of the cut protection layer 32 close to the first substrate 31 to the other end of the cut protection layer 32 close to the second substrate 34. The cut protection layer 32 may be a spacer wall of a trapezoid structure which supports the first flexible substrate 31 and the second flexible substrate 34. The cut protection layer 32 may also be a photoresist layer which supports the first flexible substrate 31 and the second flexible substrate 34. The main constituents of both the spacer wall and the photoresist layer may be resins.

In the aforesaid technical solution, the spacer wall or the photoresist layer may support the first flexible substrate and the second flexible substrate. In the related art, the thickness of the middle portion of the display panel is different from the thickness of the edge portion of the display panel when the first flexible substrate and the second flexible substrate are bent, so that the display effect of the flexible display panel is influenced. In this embodiment, the spacer wall or the photoresist layer may be disposed at the edge of the first flexible substrate and provides the function of supporting the first flexible substrate and the second flexible substrate, so that the thickness of the middle portion of the display panel is the same as the thickness of the edge portion of the display panel when the first flexible substrate and the second flexible substrate are bent. Meanwhile, the driving circuit connection layer can be protected from being damaged by laser. When the substrate in the cut region is cut by laser, the spacer wall or the photoresist layer will absorb a part of the excessive laser energy, which may reduce the risk of damaging the metal routing in the driving circuit connection layer when laser cutting is performed on the substrate at the side of the cut region of the flexible TFT-LCD, and achieve the effect of protecting the metal routing in the cut region, thereby ensuring the display effect of the flexible TFT-LCD display panel.

FIG. 4 is a flowchart diagram of a method for manufacturing a flexible display panel according to a fourth embodiment provided in this application. The method may include:

S10: acquiring a first flexible substrate and a second flexible substrate;

S11: forming a driving circuit connection layer at one side of the second flexible substrate that is towards the first flexible substrate;

S12: forming a cut protection layer between the driving circuit connection layer and the first flexible substrate, the cut protection layer corresponding to a position of the first flexible substrate on which laser cutting is to be performed;

S13: cutting the first flexible substrate by using laser with no cut protection layer being left after the laser cutting is completed.

Additionally, the method may further include the following blocks before the forming a cut protection layer between the driving circuit connection layer and the first flexible substrate, the cut protection layer corresponding to a position of the first flexible substrate on which laser cutting is to be performed:

forming a black matrix layer on the first flexible substrate.

The cut protection layer may be disposed between the driving circuit connection layer and the black matrix layer, and the cut protection layer corresponds to a position of the first flexible substrate on which laser cutting is to be performed.

The flexible display panel of this application is provided with a cut protection layer, the cut protection layer connects the edge of the first flexible substrate and the driving circuit connection layer to protect the driving circuit connection layer from being damaged by laser. The cut protection layer will absorb a part of the excessive laser energy when the substrate in the cut region is cut by using laser, so the risk of damaging the metal routing in the driving circuit connection layer may be reduced when laser cutting is performed on the substrate at the side of the cut region of the flexible TFT-LCD to achieve the effect of protecting the metal routing in the cut region, thereby ensuring the display effect of the flexible TFT-LCD display panel.

The above description depicts merely some exemplary embodiments of the disclosure but is not intended to limit the scope of the disclosure. Any equivalent structures or flow transformations made to the disclosure or any direct or indirect applications of the disclosure on other related fields shall all be covered within the protection of the disclosure.

What is claimed is:

1. A flexible display panel, comprising:
a first flexible substrate;
a second flexible substrate, disposed opposite to the first flexible substrate, wherein at least one side of the second flexible substrate extends laterally beyond the corresponding side of the first flexible substrate;
a driving circuit connection layer, disposed on the second flexible substrate, wherein a portion of the driving circuit connection layer is disposed on the portion of the second flexible substrate that extends beyond the corresponding side of the first flexible substrate;
a black matrix layer, disposed on the first flexible substrate; and
a cut protection layer, disposed between the black matrix layer and the driving circuit connection layer, wherein the cut protection layer is disposed at an edge of the first flexible substrate;
wherein the cut protection layer is a photoresist or a spacer wall comprising resins.

2. The flexible display panel of claim 1, wherein a cross-sectional area of one end of the cut protection layer connected to the second flexible substrate is greater than another end connected to the first flexible substrate of the driving circuit connection layer.

3. The flexible display panel of claim 2, further comprising: a transparent electrode layer, a color filter film layer and an alignment film layer, which are sequentially disposed on the first flexible substrate; wherein the alignment film layer is connected with the black matrix layer; wherein a liquid crystal layer and a supporting column are disposed between the first flexible substrate and the second flexible substrate, the supporting column supports the first flexible substrate and the second flexible substrate.

4. A flexible display panel, comprising:
a first flexible substrate;
a second flexible substrate, disposed opposite to the first flexible substrate, wherein at least one side of the second flexible substrate extends laterally beyond the corresponding side of the first flexible substrate;
a driving circuit connection layer, disposed on the second flexible substrate, wherein a portion of the driving circuit connection layer is disposed on a portion of the second flexible substrate that extends beyond the corresponding side of the first flexible substrate; and
a cut protection layer, connecting an edge of the first flexible substrate and the driving circuit connection layer.

5. The flexible display panel of claim 4, further comprising: a black matrix layer disposed on the first flexible substrate, wherein the cut protection layer is disposed between the black matrix layer and the driving circuit connection layer.

6. The flexible display panel of claim 5, wherein the cut protection layer is an organic colloid.

7. The flexible display panel of claim 6, wherein the cut protection layer is a precast sealant.

8. The flexible display panel of claim 5, wherein the cut protection layer is a spacer wall supporting the first flexible substrate and the second flexible substrate.

9. The flexible display panel of claim 8, wherein a cross-sectional area of one end of the cut protection layer connected to the second flexible substrate is greater than another end connected to the first flexible substrate of the driving circuit connection layer.

10. The flexible display panel of claim 5, wherein the cut protection layer is a photoresist supporting the first flexible substrate and the second flexible substrate.

11. The flexible display panel of claim 10, wherein a cross-sectional area of one end of the cut protection layer connected to the second flexible substrate is greater than another end of the cut protection layer connected to the first flexible substrate of the driving circuit connection layer.

12. The flexible display panel of claim 10, further comprising: a liquid crystal layer and a supporting column, disposed between the first flexible substrate and the second flexible substrate, the supporting column supports the first flexible substrate and the second flexible substrate;
a transparent electrode layer, a color filter film layer and an alignment film layer, which are sequentially disposed on the first flexible substrate; wherein the alignment film layer is connected with the black matrix layer.

13. A method for manufacturing a flexible display panel, comprising:
acquiring a first flexible substrate and a second flexible substrate;
forming a driving circuit connection layer on a side of the second flexible substrate towards the first flexible substrate;
forming a cut protection layer between the driving circuit connection layer and the first flexible substrate corresponding to the position of the first flexible substrate on which laser cutting is to be performed;
cutting the first flexible substrate using laser.

14. The method for manufacturing a flexible display panel of claim 13, before forming the cut protection layer between the driving circuit connection layer and the first flexible substrate corresponding to the position of the first flexible substrate on which laser cutting is to be performed, further comprising:
forming a black matrix layer on the first flexible substrate; and
disposing the cut protection layer between the driving circuit connection layer and the black matrix layer corresponding to the position of the first flexible substrate on which laser cutting is to be performed.

15. The method for manufacturing a flexible display panel of claim 13, wherein the cut protection layer is an organic colloid.

16. The method for manufacturing a flexible display panel of claim 15, wherein the cut protection layer is a precast sealant.

17. The method for manufacturing a flexible display panel of claim 13, wherein the cut protection layer is a spacer wall supporting the first flexible substrate and the second flexible substrate.

18. The method for manufacturing a flexible display panel of claim 17, wherein a cross-sectional area of an end of the cut protection layer connected to the second flexible substrate is greater than another end connected to the first flexible substrate of the driving circuit connection layer.

19. The method for manufacturing a flexible display panel of claim 13, wherein the cut protection layer is a photoresist supporting the first flexible substrate and the second flexible substrate.

20. The method for manufacturing a flexible display panel of claim 19, wherein a cross-sectional area of an end of the cut protection layer connected to the second flexible substrate is greater than another end connected to the first flexible substrate of the driving circuit connection layer.
